(19) United States
(12) Patent Application Publication
(10) Pub. No.: US 2025/0148178 A1
(43) Pub. Date: May 8, 2025

(54) METHODS OF GENERATING HARDWARE DESCRIPTION LANGUAGE (HDL)

(71) Applicant: Triad Semiconductor, Inc., Winston-Salem, NC (US)

(72) Inventors: Charles David Hutchins, Kernersville, NC (US); William James Farlow, Lewisville, NC (US)

(21) Appl. No.: 18/935,108

(22) Filed: Nov. 1, 2024

Related U.S. Application Data
(60) Provisional application No. 63/595,800, filed on Nov. 3, 2023.

(51) Int. Cl. G06F 30/323; G06F 115/06

(52) U.S. Cl. CPC G06F 30/323; G06F 2115/06

(57) ABSTRACT

Disclosed herein are methods, devices, and systems for reducing design efforts for semiconductor arrays. In one embodiment, a programmatic method for designing an ASIC is disclosed. The method includes (1) receiving application program language code, (2) determining HDL code for implementation based on the program language code, and (3) storing the HDL code in memory.

### CROSS-REFERENCE TO RELATED APPLICATIONS

This application claims the benefit of U.S. Provisional Application No. 63/595,800 (Attorney Docket No. 1141/13 PROV) filed on Nov. 3, 2023, titled “IMPROVED METHODS OF GENERATING HARDWARE DESCRIPTION LANGUAGE (HDL)” the entire contents of which are incorporated by reference.

### TECHNICAL FIELD

The present invention relates generally to application specific integrated circuits (ASICs) and more specifically to design of interconnects for semiconductor array devices.

### BACKGROUND

Full-custom application specific integrated circuits (ASICs) require all layers to be created in a custom fashion during a semiconductor process. Semiconductor arrays offer a solution over full-custom ASICs in reducing non-recurring engineering (NRE) costs, design times, and fabrication times. Semiconductor arrays also offer the ability to better address errors and reduce cycle times. However, the design cycle of a semiconductor array can occupy a significant portion of the time and cost on getting a new product to market.

As such, new methods, devices, and systems are needed for reducing design efforts for semiconductor arrays.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are methods, devices, and systems are disclosed for reducing design efforts for semiconductor arrays. In one embodiment, a programmatic method for designing an ASIC is disclosed. The method includes (1) receiving program language code, (2) determining HDL code based on the program language code, and (3) storing the HDL code in memory.

In some embodiments, the program language code may be assembly language code. In further embodiments, the assembly language code may be configured to implement a state machine. In still further embodiments, the state machine may be an opcode-controlled state machine. In certain embodiments, the assembly language code may also be configured to execute on a central processing unit (CPU) architecture.

In some embodiments, the assembly language code may be received in a spreadsheet format. In further embodiments, the spreadsheet format may be a comma-separated values CSV American Standard Code for Information Interchange (ASCII) format. In certain embodiments, the spreadsheet format may be a Microsoft Excel® format.

In other embodiments, the spreadsheet format may be a Jotform® Table format, an Apple Numbers® format, a Google Sheets® format, a Quip® format, a EtherCalc® format, a Zoho Sheets® format, an Apache OpenOffice Calc® format, a Smartsheet® format, an Airtable® format, a Stackby® format, a SeaTable® format or the like.

In other embodiments, the program language code may be machine code.

In some embodiments, the HDL code may be targeted for a configurable cell array. In certain embodiments, the configurable combinatorial cell array may be a via configurable cell array. In other embodiments, the configurable cell array may be a field-programmable gate array (FPGA).

In some embodiments, the HDL code may be very high-speed integrated circuit hardware description language (VHDL) code. In other embodiments, the HDL code may be Verilog code. In certain embodiments, the HDL code may include register-transfer level (RTL) code.

In some embodiments, the HDL code may be configured to synthesize logic circuitry. In further embodiments, the logic circuitry may include a central processing unit (CPU) architecture. In still further embodiments, the CPU architecture may include a Harvard architecture. In certain embodiments, the Harvard architecture may include a first bus for read only-memory (ROM) data and a second bus for random-access memory (RAM) data. In further embodiments, the CPU architecture may include a pipe-line architecture. In some embodiments, the CPU architecture may include a parallel computing architecture. In some embodiments, the CPU architecture may include a scalable computing architecture.

The programmatic method may further include receiving a CPU instruction set and determining the HDL code may be further based on the CPU instruction set. In further embodiments, the CPU instruction set may be a custom, standard, and/or proprietary CPU instruction set.

In some embodiments, the logic circuitry may include an opcode-controlled state machine.

In some embodiments, the programmatic method may be implemented within a first IDE. In further embodiments, the first IDE may be configured for synthesizing logic circuitry for the ASIC. In other embodiments, the programmatic method may further include transmitting the HDL code to a second IDE and the second IDE may be configured for synthesizing logic circuitry for the ASIC.

In some embodiments, the program code may be targeted for signal processing.

In some embodiments, the program code may be targeted for calibration of internal and/or external components to be associated with the ASIC.

In some embodiments, the program code may be targeted to subsystem built-in-self-test (BIST) involving both the ASIC and external components that may be connected to the ASIC during assembly.

In some embodiments, the programmatic method may be implemented on a laptop, a personal computer, a workstation, a smart tablet, a smart phone, a virtual machine, or the like.

In other embodiments, the programmatic method may be implemented on a server or a plurality of servers. In further embodiments, the server or plurality of servers may be a portion of a networked computing environment. For example, the networked computing environment may be a cloud computing environment. In certain embodiments, the programmatic method may be implemented on a virtual server or a plurality of virtual servers.

In some embodiments, the server may include an operating system (OS) hosted within a container running on the server and the programmatic method may be executed over the OS hosted within the container. In further embodiments, the container may be a Docker® container.

In another embodiment a computing device is disclosed for designing an ASIC. The computing device includes a memory and at least one processor. The computing device is configured for (1) receiving program language code, (2) determining HDL code based on the program language code, and (3) storing the HDL code in memory.

In another embodiment, a non-transitory computer-readable storage medium is disclosed. The non-transitory computer-readable storage medium stores instructions to be implemented on at least one computing device including at least one processor, the instructions when executed by the at least one processor cause the at least one computing device to perform a method for designing an ASIC. The method includes (1) receiving program language code, (2) determining HDL code based on the program language code, and (3) storing the HDL code in memory.

### BRIEF DESCRIPTION OF THE DRAWINGS

The present embodiments are illustrated by way of example and are not intended to be limited by the figures of the accompanying drawings. In the drawings:

FIG. 1 depicts a block diagram illustrating relevant logic blocks of Triad Semiconductor's OptMCU™ design hierarchy architecture in accordance with embodiments of the present disclosure.

FIG. 2 depicts a flow diagram illustrating Triad Semiconductor's OptMCU™ design implementation flow in accordance with embodiments of the present disclosure.

FIG. 3 depicts a block diagram illustrating a system for providing one or more of the previously described methods and/or IDEs in accordance with embodiments of the present disclosure.

FIG. 4 depicts one embodiment for the system server of the system of FIG. 3 in accordance with embodiments of the present disclosure.

FIG. 5 depicts a block diagram illustrating the workstation of the system 300 described in FIG. 5 in accordance with embodiments of the present disclosure.

FIG. 6 depicts a flow chart illustrating a method for reducing design efforts for semiconductor arrays in accordance with embodiments of the present disclosure.

### DETAILED DESCRIPTION

The presently disclosed subject matter is described with specificity to meet statutory requirements. However, the description itself is not intended to limit the scope of this patent. Rather, the inventors have contemplated that the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Disclosed herein are improved methods, devices, and systems for reducing design efforts (including shortening design cycles) for integrated circuits (ICs). In a broad embodiment, a programmatic method for designing an application specific integrated circuit (ASIC) is disclosed. The ASIC may be a configurable cell array, logic cell array including combinatorial and sequential circuits, memory cells, or the like. The method includes (1) receiving program language code, (2) determining hardware description language (HDL) code based on the program language code, and (3) storing the HDL code in memory. The program language code may be assembly language code configured to implement an opcode-controlled state machine when executed on an optimizable processing unit such as a microcontroller or a central processing unit (CPU) including instruction flow control and data processing units. The HDL code may be configured for synthesizing logic circuitry that includes the opcode-controlled state machine. The program language code (e.g., opcode sequences or intermediate encoding of machine language), data processing units, and sequencing units are all structured for joint logic synthesis and logic reduction.

In a preferred embodiment, an improved design methodology of complex finite state machines (FSMs) and simple micro controller units (MCUs) within structured cell arrays is disclosed.

Further disclosed is a logic circuit structure of implementing an opcode-controlled state machine. The opcode-controlled state machine has an improved implementation to map machine code, named Viacode™ read-only memory (ROM) instructions, to a via (i.e., conductive pathway between layers) configurable cell array. The via configurable cell array is typically part of a design implemented using a configurable via layer (CVL) platform. Due to the structure of the Viacode™, parameterization of features, and the synthesized implementation of the logic, the design may be optimally mapped to structured cell arrays and memory-based logic implementations such as look-up tables (LUTs) in field programmable gate arrays (FPGAs) even though the memory does not store a one-to-one mapping of the Viacode™ program instructions to memory addresses as typically found in simple CPU architectures.

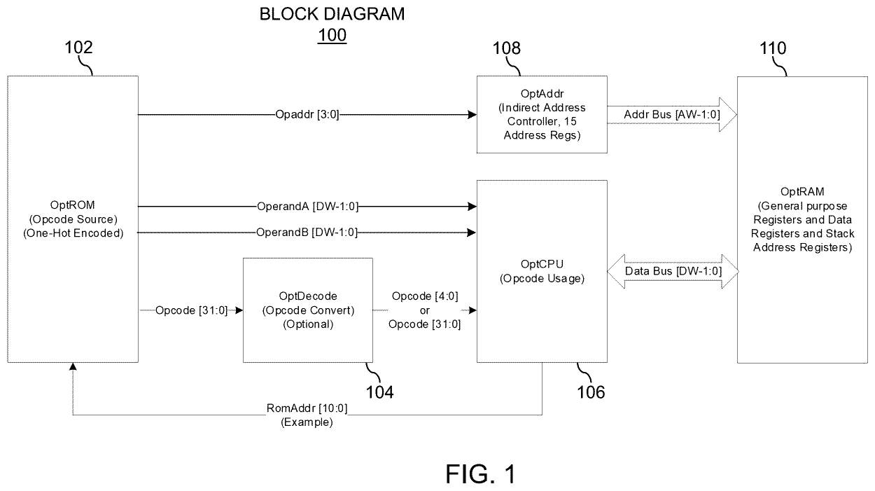

FIG. 1 depicts a block diagram 100 illustrating relevant logic blocks of Triad Semiconductor's OptMCU™ design hierarchy architecture in accordance with embodiments of the present disclosure. A basic CPU Harvard Architecture is used as method to separate program code stored in read-only memory (ROM) and a combined data random access memory (RAM) and register map bus. The disclosed architecture includes a Viacode ROM (OptROM™ 102), an instruction decoder (OptDecode™ 104), an FSM/CPU (OptCPU™ 106), and an indirect address register block (OptAddr™ 108). The disclosed architecture further includes general purpose registers, data registers, and stack registers (OptRAM™ 110). The parameterizable operand data width is shown as mnemonic label DW. Data bus and address bus widths are parameterized in register-transfer level (RTL) code to allow for implementation of the blocks to be optimized for application's data width and address space requirements. Theoretically, the OptCPU™ 106 and the OptMCU™ architecture may support any amount of address space with any data bus width with parameterized RTL coding.

Other advantages of the OptMCU™ in regard to compact implementation, are the uses of the memory address space. In the example implementation of the OptCPU™ 106, the memory and register bus is shared for use as access to general purpose registers, access to peripheral blocks, control of indirect data and address space of the analog subcircuits, and for storage of the OptCPU™ stack information which is used for subroutine calls and returns.

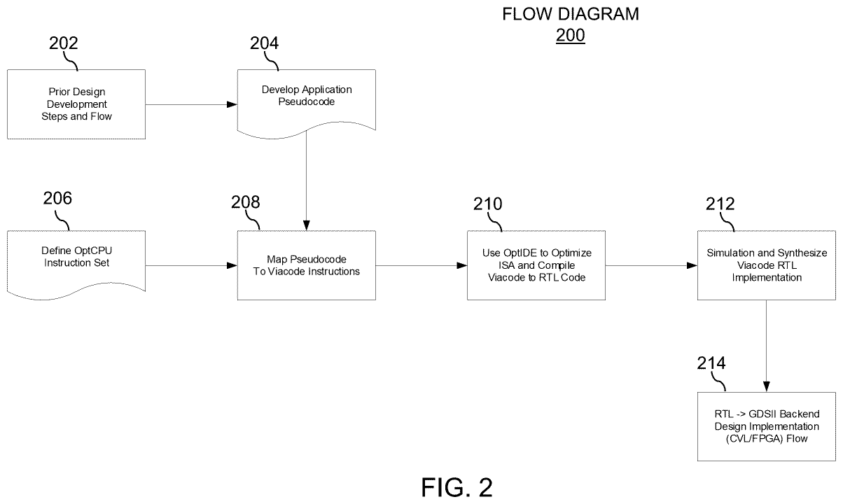

FIG. 2 depicts a flow diagram 200 illustrating Triad Semiconductor's OptMCU™ design implementation flow in accordance with embodiments of the present disclosure. The OptMCU™ design implementation flow uses Triad Semiconductor's integrated development environment (IDE) named OptIDE™. Task 202 includes prior design development steps and flow. Task 204 includes development of application pseudocode, algorithms, program code, or flow diagrams including data processing steps using the output of task 202. Task 206 includes defining an OptCPU™ instruction set. Task 208 includes mapping of pseudocode to Viacode™ instructions using the outputs of task 204 and task 206. Task 210 uses the OptIDE™ to optimize the instruction set architecture ISA and compile the Viacode™ to RTL Code using the output of Task 208. Task 212 includes simulating and synthesizing a Viacode™ RTL implementation using the output of task 210. Task 214 includes providing the Viacode™ RTL implementation of Task 212 to a layout database design implementation (CVL/FPGA) flow. For example, the layout database may be in a Graphic Design System II (GDSII). GDSII is a file format created by Calma as stream format used to control integrated circuit photomask plotting. Despite its limited set of features and low data density, GDSII has become the industry conventional stream format for transfer of IC layout data between design tools of different vendors.

Various aspects of Viacode™, OptMCU™, and OptIDE™ provide improved design implementation using the OptMCU™ development flow. These improvements include the following:
OptIDE™ real-time instruction assembly—OptIDE™ autonomously checks for valid data values and address labels as instructions are added to the program and indicates graphically which rows of code have compilation error if any.
OptIDE™ instruction code usage optimization—OptIDE™ allows for optimizing which instruction set architecture (ISA) instructions should be included in the hardware implementation with an instruction encoding enable parameter, using parameters to enable or remove instructions or modify behavior and encoding of instructions to automate optimization and tradeoffs.
OptIDE™ instruction profiling assistance—OptIDE™ may be configured to indicate the number of times that each instruction in the ISA is used in program set to assist with ISA optimizations.
OptIDE™ single file implementation for Excel—OptIDE™ may be implemented in one Excel spreadsheet file for password protection, revision control, and OptIDE™ framework updates that supports concurrent code development, collaboration, leveraging existing tools, functions, macros, etc.
OptIDE Viacode workbooks—OptIDE™ allows for separation of program code and OptIDE framework to exist as an Excel application workbook file and/or Excel program worksheet file to simplify updates to OptIDE™ framework application or implemented in a separate dynamically linked library (DLL).
OptIDE program selection—OptIDE™ allows for multiple programs and selection control of the program of which OptCPU™ processes in an implemented target application or incarnation, each of which can be specifically hardware optimized for handling the set of programs implemented.
Viacode program unbound selection encoding instruction—Theoretically, the number of instructions and their encoding is unbound in OptIDE™ and OptMCU™ architectures.
Viacode program unbound indirect addressing method—Theoretically, the number of indirect address registers is unbound in OptIDE™ and OptMCU™ architectures.
Viacode unbound program address space method—Theoretically, the address space of instructions is unbound in OptIDE™ and OptMCU™ architectures.
Viacode unbound program data width method—Theoretically, the data bus and registers widths of instructions is unbound in OptIDE™ and OptMCU™ architectures.
Viacode program synthesis to CVL array via RTL code—General flow of methodology allows for mapping of assembly code, and higher-level sequence descriptions, to be mapped to structured CVL logic cell arrays for implementation.
Viacode program synthesis to FPGA LUTs via RTL code—General flow of methodology allows for mapping of assembly code, and higher-level sequence descriptions, to be mapped to FPGA LUTs for implementation.
OptIDE and CVL flow—OptMCU™ methodology has been proven to provide full Viacode™ to GDSII methodology with custom ASIC as target application.
Optimized Viacode instruction one-hot encoding—OptMCU™ is implemented to reduce logic resources by one-hot encoding of the ISA opcodes in OptROM™ space and output of OptROM™ multiplexor is then binary encoded to reduce logic resource utilization in the OptCPU™.
OptROM multiplexing—Multiple programs may be encoded in an application implementation and selected by external control signals.
OptIDE debugger—Simulation debugger to push debugger information to and from a remote simulation host (e.g., a Linux server) from and to local OptIDE™ session.

Benefits and efficiencies of using Viacode™ versus traditional FSM or microcontroller methodologies include the following:
Viacode™ synthesis efficiency versus traditional ROMs—In some implementations mapping to less than one CVL logic cell per program instruction on average.
Smaller implementation footprint—OptMCU™ allows for irregular shape(s) to allow usage of digital resource areas that may be restrictive for traditional ROMs.
More abstract than typical FSMs—Programming assembly instruction sequences have a level of abstraction typically higher than FSM HDL coding that are used with some target applications.
Parameterized instruction data widths—Single parameter adjustment to data width of RTL although other supporting blocks may need adjusting for relevant changes.
Parameterized instruction and data address spaces—Single parameter to adjustment to address space of RTL although supporting IP blocks may need adjusting for relevant changes.
Instruction set compatibility—Emulating ISAs of single or multiple address locations per instruction for compatibility can be adjusted via the OptIDE™ instruction set architecture definition worksheet.
Logic cell compactness—cells of OptROM™ and logic redundancy in general can be made to intertwine during place and route for area efficiency.
Design mapping—OptROM™ and OptMCU™ logic may be hardened to standard cells (i.e., full custom ASICs).

When using the OptMCU architecture certain tradeoffs may be encountered while gaining the previously described improvements. For example, an area of implementation before mapping may only be an estimate when targeting logic cells and LUTs. The OptMCU™ may use more area than an FSM targeted implementation and may be less reprogrammable than electrically erasable programmable read-only memory (EEPROM) or microcontroller-based implementations in ASICs. OptROM™ logic delay paths may be longer than traditional ROM read access cycles. Also, higher levels of program code abstraction exist for microcontroller implementations than with existing implementations of OptMCU using Viacode, however standard programming languages using existing compiler technology could be used to translate higher level programs to Viacode and OptMCU.

A problem is that some MCU architectures (e.g., some variants of OptMCU™) may have multiple addresses per instruction in the “program code” (e.g., a two-byte instruction or a three-byte instruction). Implementing the program in multiple addresses per instruction may not be the optimal implementation of the “program” but the enhanced implementation may need to retain compatibility of some aspects of the “program” such as program counter value for individual instructions stored in memory. In addition, the size of operands and method of accessing them typically determine memory requirements and may not be optimal or implementable depending on what resources are available in the target device (e.g., a structured ASIC or an FPGA). While implementing such opcodes and operands for a OptMCU™ and Viacode™ program methodology, opcode encoding methods may be used that are not typically used in memory-based solutions due to the inefficiency of storing the “program” in memory. To implement these features of the OptMCU™, an IDE software tool (OptIDE™) was implemented using a spreadsheet to provide a coding environment that provides simple implementation and changes to the OptMCU™ features for the target design. To reduce code footprint, an optional OptAddr™ block may be used to implement indirect addressing of the register map bus address control.

The disclosed solution is to implement a logic circuit and Viacode™ “program” that allows for the OptMCU™ to operate in single cycle per instruction mode and retain instruction addressing compatibility with the “program” if needed. The solution further implements the OptMCU with a parallel instruction bus allowing it to potentially fetch an instruction every clock cycle and have a program counter increment its value assigned to each instruction to provide an improved solution to optimizing effective cycles per instruction of the “program”. In some applications, adjustments to the data bus width may be needed so the OptIDE™ and RTL are parameterized to allow for simplification of changing design attributes. Changing RAM or ROM widths may not be used if implemented in synthesized logic structure but rather only needed for available logic resources. In some cases, the additional resources may be optimized due to logic synthesis optimization. The additional resources may be further available to be optimized for available logic resources and to provide for quick tradeoff analysis of time versus area, as example. In all cases, resources are optimized due to logic synthesis optimization so tradeoffs in key metrics can be automated.

The OptIDE™ also provides a method of restricting inputs to valid opcodes only, a simple method of defining new opcodes, performing real-time recompiles, generating necessary RTL code file, and keeping all necessary information for implementation in one spreadsheet file using Microsoft Excel as the spreadsheet application basis.

The disclosed solution is to implement a logic circuit and program opcode encoding to further optimize the resources needed to implement the design versus the typical method of storing the opcode in a RAM, ROM, or synthesized logic with typical binary encoding. The herein solution compiles opcodes from the program into a one-hot encoding instead of binary encoding. To improve resource utilization, the FSM/CPU may use one-hot to binary encoding rather than one-hot encoding directly in the instruction decoder. This lessens the required resources due to optional pipelining stages of the instruction opcode which would require less storage elements than when using and storing values for one-hot encoding. To implement the OptCPU™ with binary opcode, a one-hot to binary encoder logic circuit in the opcode data signal path is needed. Additionally, the OptCPU™ may use the one-hot encoding method directly depending on design pipelining and necessary mapped resources reported from synthesizing the design.

The disclosed solution implements logic circuits and Viacode™ “program” opcode encoding to further optimize the resources needed to implement the design versus the typical method of storing the opcode in a RAM or ROM. The disclosed solution further compiles a Viacode™ “program” from the program code (i.e., assembly code) into RTL code of a multiplexor structure for synthesis into combinatorial cells. The synthesized netlist may then be mapped to a via-configurable array of logic cells that could also include logic cells for the FSM/CPU and controller of the target design.

Due to the number of instructions in each “program”, the OptMCU™ architecture supports dividing the “program” into “sub-programs”. The “sub-programs” are basically different “program” Viacode™ ROMs that have a multiplexor on their outputs. The OptIDE™ supports generating the proper “sub-program” selection signal to select the proper Viacode™ ROM to process. One reasoning for this feature is to reduce the depth of logic paths in the synthesized Viacode™ ROMs, thus allowing for faster clock frequency for the OptMCU™ portion of the respective design.

The logic circuit structure of implementing an opcode-controlled state machine has an improved implementation to map machine code, the Viacode™ ROM instructions, to a via configurable cell array. Doing so allows for reconfigurability of the Viacode™ “program” with via cell routing changes to the layout of the target circuit.

The indirect address control block example, which allows up to fifteen indirect address registers and reserves address select 0 for direct addressing from the OptCPU™ address bus. The selection is directly controlled by a value set in the OptROM™ program multiplexor logic with its value configured in the OptIDE during Viacode™ development. This allows any instruction that access the address bus to use indirect addressing features. The setting of indirect addressing register values may be performed as a common register bus access as shown in FIG. 1.

The OptMCU™ RTL code generator may be configured with a parameter for each instruction defining what value to increment the program counter by on each instruction fetch clock cycle. The OptMCU™ coding OptIDE™ allows for calculation of instruction addresses based on the generator instruction parameters or on a generalized single cycle per instruction. The OptMCU™ IDE has an addressing mode selection field and a field to set the operand data width parameter. The data width field shall be used to adjust the data widths of the generated Viacode “program” ROM multiplexer. For the synthesized “ROM”, optimization is due to common operand values such as the upper 8-bits of integers 0x0012 and 0x0034 which may not require significantly more logic resources to implement as opposed to 0x12 and 0x34 in an 8-bit data bus application.

For a 32-opcode instruction set architecture, the no-operation instruction opcode 0x0000_0001 or some other instruction opcode 0x8000_0000 in the synthesized program multiplexor may be mapped to a via-configurable ASIC such as the one developed by Triad Semiconductor, Inc. The program multiplexor selection bits may be controlled by the FSM/CPU as a program counter where it may present encoded machine code instructions in a range of 0x00 (NOP) to 0x31 (another instruction). If the opcodes are encoded such as one-hot encoding, then the FSM/CPU may act on individual bit index of the 32-bit opcode to determine the instruction to perform the operation. Using via-placement based routing the program and FSM/CPU function of the design may be changed. In the example, the 5-bit based FSM/CPU and decoder used a few less resources than the one-hot encoded instruction set version of the FSM/CPU which looked at each bit index of the 32-bit opcode to determine the instruction operation to perform. Since one-hot encoding of the “program” opcode used less resources than the encoded 5-bit format when synthesized, the one-hot encoding of the “program” opcodes was used in the example design.

Additionally, the OptMCU™ derivatives may be used as a redundant customized blocks for certain designs. The OptMCU™ architecture may also be used as a substitution for developing complicated FSMs, particularly those targeted for implementation in configurable via layer array ASICs.

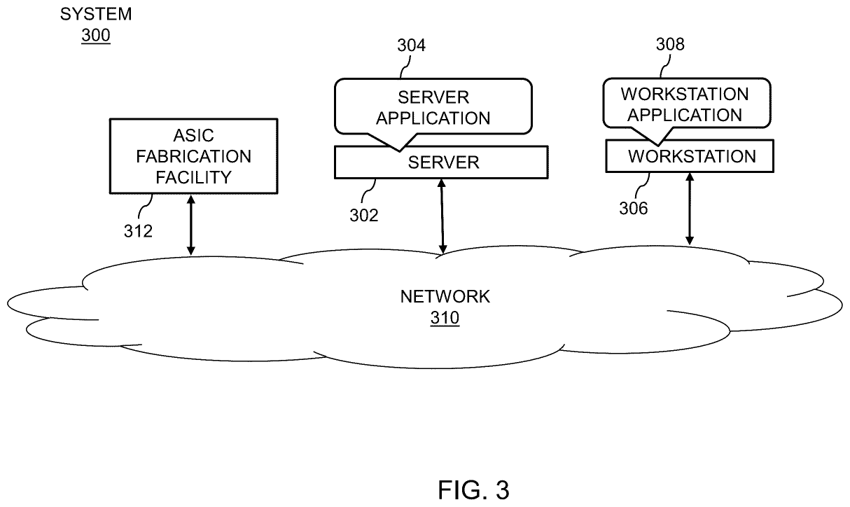

FIG. 3 depicts a block diagram illustrating a system 300 for providing one or more of the previously described methods and/or IDEs in accordance with embodiments of the present disclosure. The system 300 includes a system server 302 executing a system server application 304. The system server application 304 may implement any of the previously described methods disclosed herein. The system 300 also includes a workstation 306 executing a workstation application 308. The workstation application 308 may implement any of the previously described methods disclosed herein. The system server 302 is configured to communicate with the workstation 306 over the network 310. In some embodiments, the system server application 304 will execute a first portion of the methods described herein and the workstation application 308 will execute a second portion of the methods described herein. The network 310 may be any type or combination of wired, wireless, and/or optical networks. The network 310 may include one or more wide area networks (WANs), local area networks (LANs), and personal area networks (PANs). The network 310 may also include the Internet. The system 300 also includes an ASIC fabrication facility 312 for producing semiconductor arrays. HDL, RDL, or mask files may be transmitted over the network 310 from either the system server 302 or the workstation 306 to the ASIC fabrication facility 312. In other embodiments, the workstation 306 may provide a custom file suitable for programming an FPGA. The custom file may be provided over the network 310 or via another interface from the workstation 306.

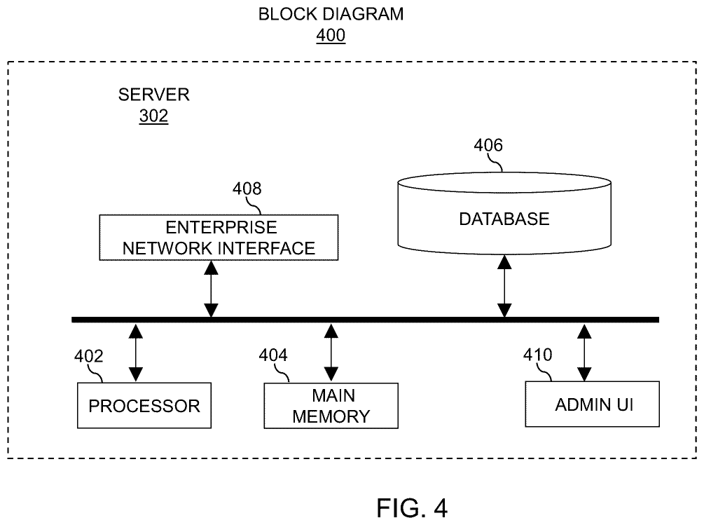

FIG. 4 depicts one embodiment for the system server 302 of the system 300 of FIG. 3 in accordance with embodiments of the present disclosure. The system server 302 is a hardware server and may include a processor 402, a main memory 404, a database 406, a datacenter network interface 408, and an administration user interface (UI) 410. The system server 302 may be configured to host a virtual server. For example, the virtual server may be an Ubuntu® server, RedHat® (i.e. Linux) server, OpenBSD® server, FreeBSD® server, or the like. The system server 302 may also be configured to host a virtual container. For example, the virtual container may be the Docker® virtual container or the like. In some embodiments, the virtual server and or virtual container may be distributed over a plurality of hardware servers using hypervisor technology. The system server 302 may be implemented in the Microsoft Azure®, the Amazon Web Services® (AWS), or the like cloud computing data center environments. In other embodiments, the system server 302 may be hosted within a business or residential environment.

The processor 402 may be a multi-core server class processor suitable for hardware virtualization. The processor 402 may support at least a 64-bit architecture and a single instruction multiple data (SIMD) instruction set. The main memory 404 may include a combination of volatile memory (e.g., random access memory) and non-volatile memory (e.g., flash memory). The database 406 may include one or more hard drives. In some embodiments, the database 306 may be an open source database such as the MongoDB® database, the PostgreSQL® database, or the like. The database 406 may be configured to store one or more ASIC libraries and one or more ASIC designs.

The enterprise network interface 408 may provide one or more high-speed communication ports to the data center switches, routers, and/or network storage appliances. The enterprise network interface 408 may include high-speed optical Ethernet, InfiniBand (IB), Internet Small Computer System Interface iSCSI, and/or Fibre Channel interfaces. The administration UI 410 may support local and/or remote configuration of the system server 302 by a data center administrator or the like. The enterprise network interface 408 allows the system server 302 to communicate over the network 310.

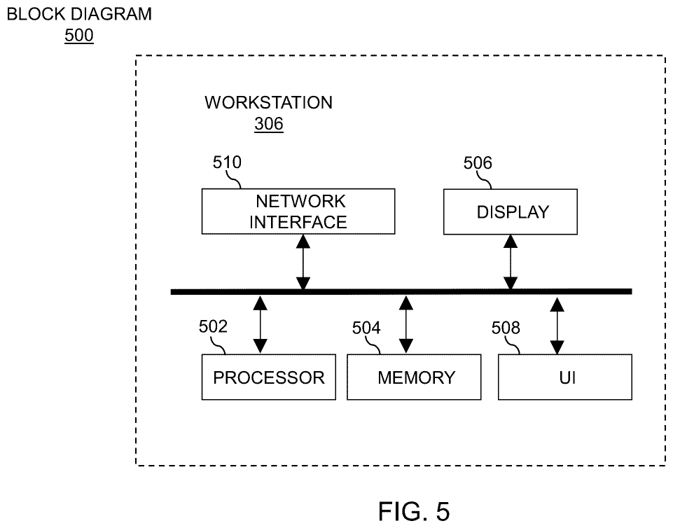

FIG. 5 depicts a block diagram 500 illustrating the workstation 306 of the system 300 described in FIG. 5 in accordance with embodiments of the present disclosure. The workstation 306 may be configured to communicate with the system server 302 over the network 310 in a similar manner as described in the system 500 of FIG. 5. The workstation 506 may be configured to host a specific application (e.g., the workstation application 308), a browser application, a third party application, and/or the like. The workstation 306 includes at least one processor 502, a memory 504, a display 506, a user interface (UI) 508, and a network interface 510.

The workstation 306 may include an operating system (OS) such as a Windows® OS, a Macintosh® OS, a Linux® OS, or the like. The memory 504 may include a combination of volatile memory (e.g., random access memory) and non-volatile memory (e.g., solid state drive and/or hard drives). The display 506 may be an external display (e.g., computer monitor) or internal display (e.g., laptop). The UI 508 may include a keyboard, and a pointing device (e.g., mouse). The network interface 510 may be a wired Ethernet interface or a Wi-Fi interface. Additionally, the workstation 306 may include one or more interfaces (not shown in FIG. 5) for programming an FPGA.

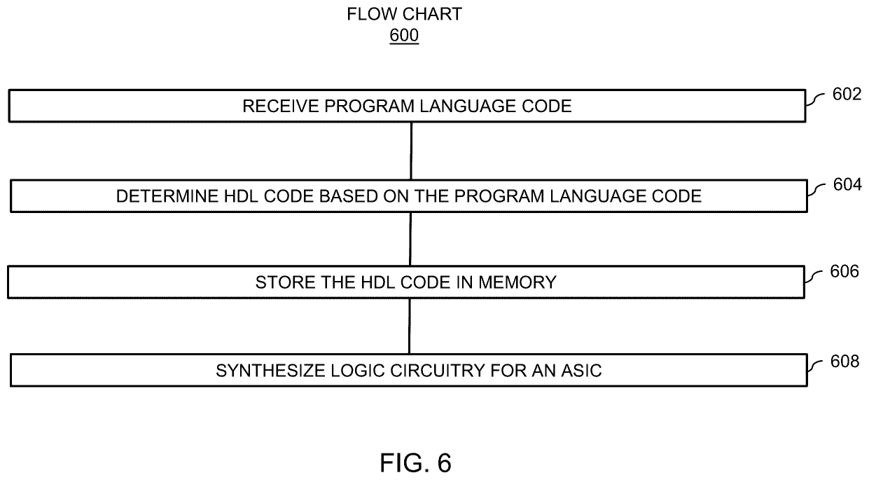

FIG. 6 depicts a flow chart 600 illustrating a programmatic method for designing an ASIC in accordance with embodiments of the present disclosure. The programmatic method may be implemented on one or more computing devices. The computing devices may include one or more servers, laptops, personal computers, workstations, smart tablets, smart phones, and/or the like. Additionally, the programmatic method may be implemented within the system 300 of FIG. 3. One or more hardware accelerators may also be used to implement at least a portion of the programmatic method. The programmatic method may be stored as instructions on a non-transitory computer-readable storage medium. The instructions may be configured to be implemented on one or more of the previously described devices.

In step 602, the programmatic method includes receiving program language code. The program language code may be assembly language code and may be configured to implement a state machine. The state machine may be an opcode-controlled state machine. Additionally, the assembly language code may also be configured to execute on a central CPU architecture. The assembly language code may be received in a spreadsheet format. The spreadsheet format may be a comma-separated values CSV format. The spreadsheet format may also be a Microsoft Excel® format, a Jotform® Table format, an Apple Numbers® format, a Google Sheets® format, a Quip® format, a EtherCalc® format, a Zoho Sheets® format, an Apache OpenOffice Calc® format, a Smartsheet® format, an Airtable® format, a Stackby® format, a SeaTable® format, or the like. Alternately, the program language code may be machine code.

In step 604, the programmatic method further includes determining HDL code based on the program language code. In step 606, the programmatic method further includes storing the HDL code in memory. The programmatic method may further include receiving a CPU instruction set and determining the HDL code may be further based on the CPU instruction set.

The HDL code may be targeted for a configurable cell array. The configurable combinatorial cell array may be a via configurable cell array. The configurable cell array may also be a field-programmable gate array (FPGA).

The HDL code may be very high-speed integrated circuit hardware description language (VHDL) code or Verilog code. Additionally, the HDL code may include register-transfer level (RTL) code.

In step 608, the programmatic method further includes synthesizing logic circuitry for the ASIC. The logic circuitry may include a CPU architecture. For example, the CPU architecture may include a Harvard architecture that further includes a first bus for ROM data and a second bus for RAM data. The logic circuitry may include an opcode-controlled state machine.

Steps 602, 604, and 606, of the programmatic method may be implemented within a first IDE. Step 608 of the programmatic method may be implemented within the first IDE or a second IDE remote from the first IDE.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A programmatic method for designing an application specific integrated circuit (ASIC), the method comprising:
receiving program language code;
determining hardware description language (HDL) code based on the program language code; and
storing the HDL code in memory.

2. The programmatic method of claim 1, wherein the program language code is assembly language code.

3. The programmatic method of claim 2, wherein the assembly language code is configured to implement a state machine.

4. The programmatic method of claim 3, wherein the state machine is an opcode-controlled state machine.

5. The programmatic method of claim 2, wherein the assembly language code is configured to execute on a central processing unit (CPU) architecture.

6. The programmatic method of claim 2, wherein the assembly language code is received in a spreadsheet format.

7. The programmatic method of claim 1, wherein the program language code is machine code.

8. The programmatic method of claim 1, wherein the HDL code is targeted for a configurable cell array.

9. The programmatic method of claim 8, wherein the configurable cell array is a via configurable cell array.

10. The programmatic method of claim 8, wherein the configurable cell array is field-programmable gate array (FPGA).

11. The programmatic method of claim 1, wherein the HDL code includes register-transfer level (RTL) code.

12. The programmatic method of claim 1, wherein the HDL code is configured to synthesize logic circuitry.

13. The programmatic method of claim 12, wherein the logic circuitry includes a central processing unit (CPU) architecture.

14. The programmatic method of claim 13, wherein:
the CPU architecture includes a Harvard architecture; and
the Harvard architecture comprises a first bus for read only memory (ROM) data and a second bus for random access memory (RAM) data.

15. The programmatic method of claim 13 further comprising receiving a CPU instruction set and determining the HDL code is further based on the CPU instruction set.

16. The programmatic method of claim 13, wherein the logic circuitry includes an opcode-controlled state machine.

17. The programmatic method of claim 1, wherein the programmatic method is implemented within a first integrated development environment (IDE).

18. The programmatic method of claim 17, wherein the first IDE is configured for synthesizing logic circuitry for the ASIC.

19. The programmatic method of claim 17 further comprising transmitting the HDL code to a second IDE, wherein the second IDE is configured for synthesizing logic circuitry for the ASIC.

20. A computing device for designing an application specific integrated circuit (ASIC), the computing device comprising:
a memory; and
at least one processor configured for:
receiving program language code;
determining hardware description language (HDL) code based on the program language code; and
storing the HDL code in memory.

21. A non-transitory computer-readable storage medium, the non-transitory computer-readable storage medium storing instructions to be implemented on at least one computing device including at least one processor, the instructions when executed by the at least one processor cause the at least one computing device to perform a method for designing an application specific integrated circuit (ASIC), the method comprising:
receiving program language code;
determining hardware description language (HDL) code based on the program language code; and
storing the HDL code in memory.
